(19) United States
(12) Patent Application Publication
(10) Pub. No.: US 2026/0042366 A1
(43) Pub. Date: Feb. 12, 2026

(54) Electric Vehicle with a Charging Interface Device

(71) Applicant: Dr. Ing. h.c. F. Porsche Aktiengesellschaft, Stuttgart (DE)

(72) Inventors: Jan Siebert, Winnenden (DE); Dominik Beierl, Korntal-Münchingen (DE)

(73) Assignee: Dr. Ing. h.c. F. Porsche Aktiengesellschaft, Stuttgart (DE)

(21) Appl. No.: 19/295,882

(22) Filed: Aug. 11, 2025

(30) Foreign Application Priority Data
Aug. 12, 2024 (DE) 102024122943.8

(51) Int. Cl. B60L 53/16; B60L 53/18

(52) U.S. Cl. CPC B60L 53/16; B60L 53/18

(57) ABSTRACT

An electric vehicle having a charging interface device. The charging interface device is configured to charge a traction battery of the electric vehicle. The charging interface device includes a charging cradle, a charging socket disposed in the charging cradle, and lines formed between the charging socket and the traction battery, an AC line, and a DC line. The charging socket is configured to be integrated in the charging cradle, wherein at least the DC current line is mechanically connected to the charging cradle.

### CROSS-REFERENCE TO RELATED APPLICATION

This application claims priority to German Patent Application No. 10 2024 122 943.8, filed Aug. 12, 2024, which is incorporated by reference herein in its entirety.

### FIELD OF THE INVENTION

The invention relates to an electric vehicle having a charging interface device.

### BACKGROUND OF THE INVENTION

Electric vehicles having traction batteries are sufficiently known. The charging interface device comprises a charging unit with a charging socket for a charging plug of a charging column configured outside the electric vehicle, which is accessible via a charging opening of a body part of a body of the electric vehicle. The charging opening is closed with the aid of a charging lid of the charging interface device, in particular during driving operation of the electric vehicle. The charging lid is movable for opening and closing the charging opening. AC power lines and DC power lines are disposed between the traction battery and the charging socket for supplying power to the traction battery.

DE 10 2019 118 910 A1, which is incorporated by reference herein, discloses a charging interface device of an electric vehicle comprising a charging cradle and a charging socket, wherein the charging socket is connected to the AC lines and DC lines via plug-in connections.

A charging interface device of an electric vehicle is known from DE 10 2016 206 002 A1, which is incorporated by reference herein, wherein a charging socket of the charging interface device is manufactured in one piece with the charging cradle of the charging interface device, or is connected to the charging cradle in a positive-locking, material-locking and/or friction-locking manner.

### SUMMARY OF THE INVENTION

An electric vehicle according to the present invention has a charging interface device configured to charge a traction battery of the electric vehicle. The charging interface device comprises a charging cradle, a charging socket disposed in the charging cradle, and lines configured between the charging cradle and the traction battery, an AC line and a DC line. According to aspects of the invention, the charging socket is configured to be integrated into the charging cradle, wherein at least the DC current line is mechanically connected to the charging cradle. That is to say, in other words, the charging socket is received in the charging cradle and the charging cradle with the charging socket forms a charging module that is mountable in a body of the electric vehicle. The DC line is mechanically connected to the charging cradle. One advantage is that this makes it possible to vary the charging socket within the charging cradle and a variance typically formed between the lines and the charging socket is eliminated. Finally, simple mountability is realized as the charging cradle with the charging socket can be installed in the form of the charging module.

A further significant advantage is that, since the DC line is connected to the charging socket, and is thus fixed to the charging cradle, no initiation of force acts on the charging socket when the DC line is mounted, but rather the initiation of force is carried out via the connection of the charging cradle to the body on corresponding body parts. This can increase process reliability. A connection between the charging socket and the DC line, which is particularly configured during a charging process, thus does not require any force, because mounting forces can be supported on the charging cradle.

To establish the connection between the DC current line and the charging cradle, the charging cradle comprises a DC current coupling element, which is at least partially complementary to a further DC current coupling element of the DC current line. The coupling elements are configured in the form of plug elements, for example, and thus comprise a plug and a socket. This connection, which is in the form of a plug-in connection, can additionally be secured with a screw connection. The screw connection may also be configured alone.

A separable connection may be formed between the charging cradle and the charging socket. The advantage of this is that a connection is formed between components of the charging interface device configured to carry current only for charging, and therefore only during a charging process of the traction battery. Once the charging process is complete, the connection between the charging cradle and the charging socket, thus between the components of the charging cradle and the charging cradle configured to carry current, can be disconnected.

To the extent that the charging socket is movable relative to the charging cradle, the essential advantage of the charging socket is to be arranged flush, or at least nearly flush with an outer shell of the body.

The charging socket may be integrated into the charging cradle with the aid of a receiving device. The receiving device is in particular advantageous if the charging socket is movable relative to the charging cradle, since a corresponding movement kinematics can be realized with the aid of the receiving device.

Advantageously, the AC line is a flexible line and the DC line is a rigid line (i.e, more rigid than the flexible line) so that a reduction in current resistance can be provided during charging of the traction battery due to the rigid line.

In particular, if the DC power line is configured in the form of a rigid line, it is advantageous to carry out the connection of the charging cradle to the DC power line in order to provide for a temperature compensation and/or tolerance compensation.

A stable connection of the charging module to the body can be achieved, provided that the charging cradle is mounted to a holder of a trim part of a body of the electric vehicle. The trim part is typically secured at several points on a shell part of the body so that a large triangular force can be formed, which can secure the bracket of the charging module.

### BRIEF DESCRIPTION OF THE DRAWINGS

Additional advantages, features, and details of the invention arise from the following description of preferred exemplary embodiments, as well as with reference to the drawings. The features and feature combinations specified hereinabove in the description, as well as the features and feature combinations mentioned hereinafter in the description of the drawings and/or shown alone in the drawings, can be used not only in the respectively specified combination, but also in other combinations, or on their own, without departing from the scope of the invention. Identical or functionally identical elements are assigned identical reference signs. For the purpose of clarity, it is possible that the elements are not marked with their reference numeral in all figures, however this does not negate their allocation. The figures show:

FIG. 1 in an exploded view, a charging interface device of an electric vehicle according to the prior art,

FIG. 2 in an exploded view, a charging interface device of an electric vehicle according to aspects of the invention in a first exemplary embodiment,

FIG. 3 in an exploded view, the charging interface device of the electric vehicle according to aspects of the invention in a second exemplary embodiment,

FIG. 4 in a sectional view, the electric vehicle according to aspects of the invention with the charging interface device according to the second exemplary embodiment,

FIG. 5 in a side view, a charging module of the charging interface device according to FIG. 4 with an AC line,

FIG. 6 in a rear view, a charging module of the charging interface device,

FIG. 7 in a sectional view, the electric vehicle according to aspects of the invention with the charging interface device according to a third exemplary embodiment,

FIG. 8 in a side view, a section of a body of the electric vehicle according to aspects of the invention, and

FIG. 9 in a schematic diagram, the charging module of the charging interface device.

### DETAILED DESCRIPTION OF THE INVENTION

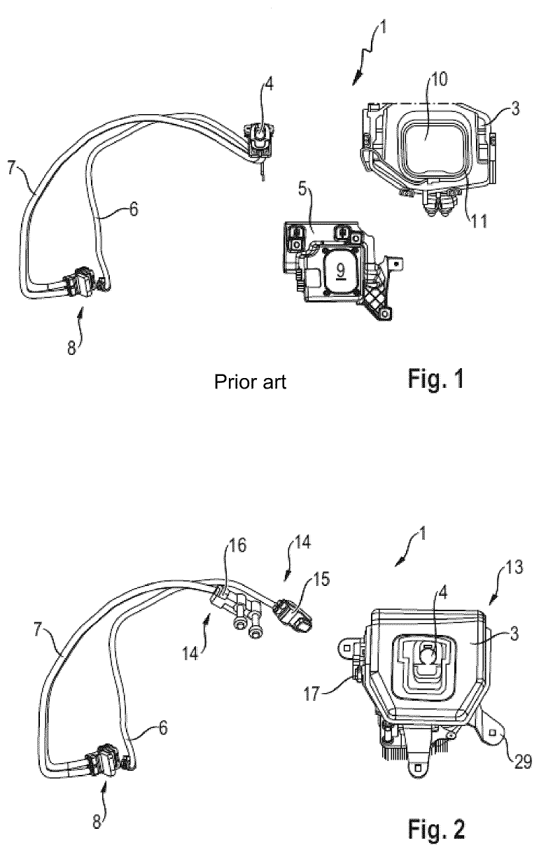

FIG. 1 illustrates a charging interface device 1 of an electric vehicle 2 according to the prior art in an exploded view, wherein the charging interface device 1 comprises a charging cradle 3, a charging socket 4 and a charging socket holder 5. The charging socket 4 is connected to the charging socket holder 5, which is attached to the charging cradle 3.

Between a traction battery of the electric vehicle 2, not shown in further detail, and the charging socket 4, energy transfer means are configured in the form of an AC line 6 and a DC line 7. The lines 6, 7 are fixedly connected to the charging socket 4 on one end and to the traction battery on the other, wherein the plug-in connection means 8 secures the connection between the lines 6, 7 and the traction battery.

The lines 6, 7 can be fixedly connected to the charging socket 4 even before they are received in the charging socket holder 5. The charging socket holder 5 has an opening 9 through which the charging socket 4 is at least partially inserted.

The charging cradle 3 comprises a charging lid 10, which is configured to close or release a shell opening 11 of the charging cradle 3. The charging socket 4 is received for operability in the shell opening 11 of the charging cradle 3. With the aid of the charging lid 10, the charging socket 4 is in particular protected from ingress of dirt and moisture, which is why the charging lid 10 is preferably arranged so as to completely close the shell opening 11 during driving operation of the electric vehicle 2.

During charging operation of the electric vehicle 2, the charging lid 10 is positioned to release the shell opening 11 and the charging socket 4 so that a charging plug of a charging column, which is configured at least partially complementary to the charging socket 4 and is not shown in more detail, can be inserted into the charging socket 4 for charging the traction battery.

The charging interface device 1 of an electric vehicle 2 according to aspects of the invention is constructed as depicted in FIG. 2. The charging socket 4 is configured to be integrated into the charging cradle 3 such that the charging cradle 4 forms a charging module 13 with the charging cradle 3, and so that they are already connected to one another before being mounted on a body 12 of the electric vehicle 2. Thus, at least the charging cradle 3 is configured with the charging socket 4 in the form of the charging module 13, which is mountable.

The lines 6, 7 are configured at their ends 14 facing the charging socket 4 to complete an electrical connection with the charging socket 4. The AC power line 6 has an AC coupling element 15 for this purpose, which can already be connected to a further AC coupling element, not shown here, which is at least partially complementary in its configuration, prior to the installation of the charging module 13 on the charging cradle 3 or the charging socket 4. The connection can already be made prior to the mounting of the charging module 13, since the AC current line 6 is configured in the form of a flexible line. Of course, it could also be connected to the same after the mounting of the charging module 13. The term flexible line is to be understood to mean a line that is designed in the form of an electrical cable commonly used to transmit alternating current that is configured to be bendable manually without significant force, meaning that it is limp.

The DC line 7 has a DC coupling element 16 configured facing the charging cradle 3 and is mechanically connected to the charging cradle 3. To achieve a simple assembly of the DC line 7 with the charging cradle 3, the charging cradle 3 has a further DC coupling element 17, which is at least partially complementary to the DC coupling element 16 and is configured to complete a live connection.

The further DC coupling element 17 is configured on an outer surface 18 of the charging cradle 3, in particular on a side wall 19 of the charging cradle 3, which is accessible after the charging module 13 has been mounted so that the DC coupling element 16 can be easily connected to the further DC coupling element 17. At this point, it should be mentioned that the DC current coupling element 16 can be configured in the form of a plug or a socket, wherein the further DC current coupling element 17 is configured at least partially complementary in the form of a socket or a plug.

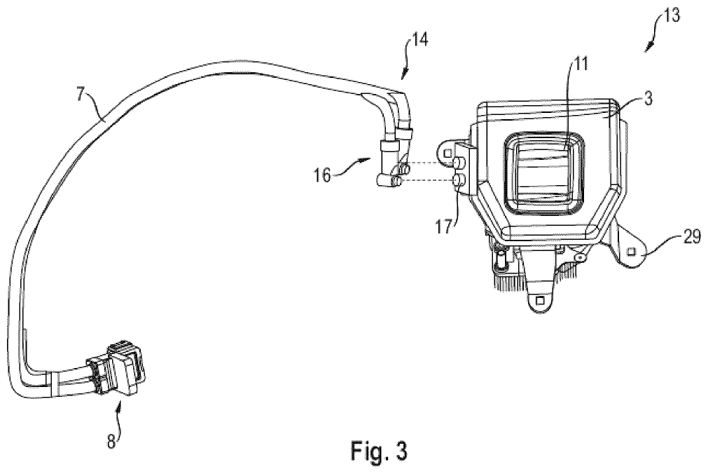

In FIG. 3, the charging interface device 1 of the electric vehicle 2 according to aspects of the invention is partially depicted according to a second exemplary embodiment. The charging cradle 3 of the charging module 13 comprises a variant of the further DC coupling element 17, wherein, correspondingly, the DC coupling element 16 is changed for partial receiving for establishing a current-conducting connection, as compared to the DC coupling element 16 of the electric vehicle 2 according to the first exemplary embodiment. The two DC current coupling elements 16, 17 are configured to complete a plug-screw connection.

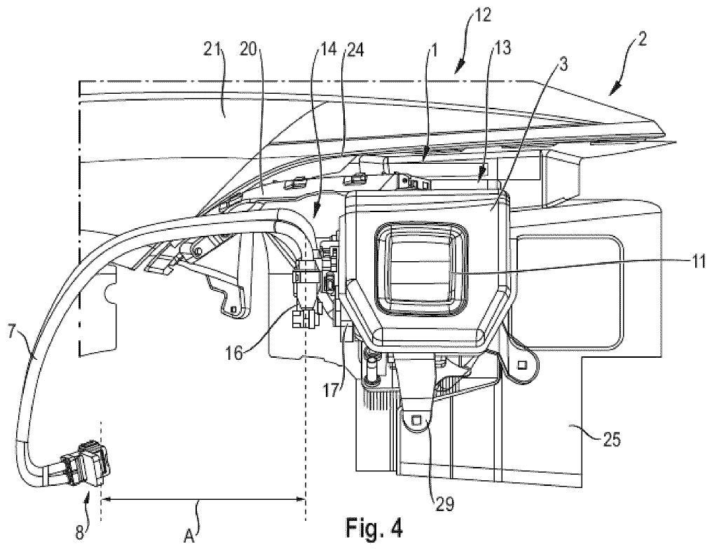

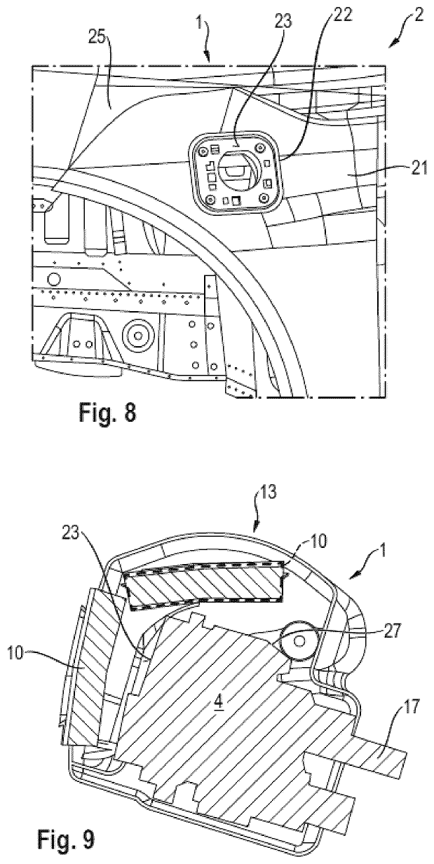

In FIG. 4, in a sectional view, the electric vehicle 2 according to aspects of the invention is illustrated with the charging interface device 1 in a mounted state. The charging module 13, comprising the charging cradle 3 and the charging socket 4, is mounted and secured to a retaining element 20 of a rear cladding 21 of the body 12, as shown in FIG. 8.

The rear cladding 21 has an element opening 22 which can be covered with the aid of the charging lid 10. To precisely position this element opening 22 over the charging socket 4, or in other words, to precisely position the element opening 22 over an operator interface 23 of the charging socket 4, the rear cladding 21 is aligned with a groove 24 of an adjacent shell part 25 of the body 12. The rear cladding 21 is received in this groove 24 and positioned accordingly.

The DC line 7 is configured in the form of a rigid line, or in other words, a non-flexible line, preferably formed of aluminum, compared to the AC line 6, which is flexible, and thus limp, which comprises strands. The DC power line 7 is to be mounted separately, providing the advantage that a variance of the DC power line 7 is no longer relevant.

The connection of the charging cradle 3 to the DC line 7 is configured to provide for temperature compensation and/or tolerance compensation. Between its DC coupling element 16 and its plug-in connection means 8, with the help of which it is connected to the traction battery, the DC line 7 has a distance A, which is particularly configured in the direction of a longitudinal axis of a motor vehicle. During its assembly, a corresponding force requirement is necessary due to its rigid design, wherein the applied force is applied on the charging cradle 3, since the charging socket 4 is decoupled from the further DC coupling element 17 at least during assembly. Thus, the advantage is that the connection formed between the charging socket 4 and the further DC coupling element 17 during a charging process is configured to be force-free, meaning in particular that it involves no mechanical stresses, or in other words, is configured to be tension-free.

In the present exemplary embodiment, the tolerance can only be absorbed by a certain elasticity of the DC line 7. This elasticity can be seen in the fact that the DC current line 7, which is preferably formed from aluminum in the form of a solid circular rod, is movable in a “springy” manner in a range of a few millimeters.

In the present exemplary embodiment, three connection elements 29 of the charging module 13 are configured to connect the charging module 13 to the body 12, in particular to the shell part 25. A further connection element 29 is configured to connect to the retaining element 20.

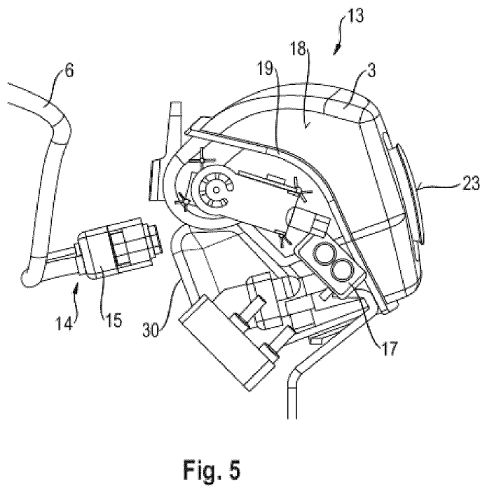

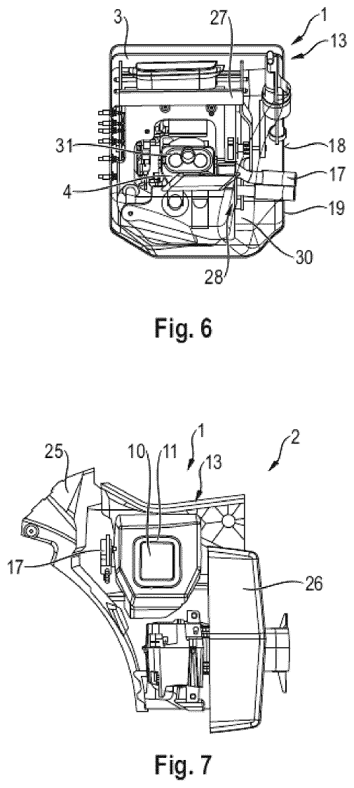

As illustrated in FIG. 5, in which the charging module 13 is depicted in a side view with the AC line 6, the AC coupling element 15 can be disposed on a rear wall 30, which is configured to face away from the operator interface 23. The AC coupling element 15 of the AC line 6 is connectable to a further AC coupling element 31 of the charging module 13, which is depicted in FIG. 6, in which the charging module 13 is illustrated in a rear view. The further AC coupling element 31 is disposed in the charging socket 4.

The charging socket 4 is integrated into the charging cradle 3 with the aid of a receiving device 27 of the charging module 13. In the present exemplary embodiment, the charging socket 4 is movably configured relative to the charging cradle 3 with the aid of the receiving device 27.

A connection between the charging socket 4 and the further DC coupling element 17, which is configured for the secured power transmission, is realized with the aid of a coupling unit 28. The connection may be configured to be inseparable, in particular if the charging socket 4 is immovably received in the charging cradle 3. However, it can also be separable regardless of whether the charging socket 4 is configured as movable or non-movable relative to the charging socket 3. That is to say, the coupling unit 28 is divisible, with one part of the coupling unit 28 being fixedly connected to the charging socket 4 and the other part of the coupling unit 28 being fixedly connected to the charging cradle 3.

The DC line 7 is, as configured, preferably connected to the charging cradle 3 by means of a plug-in connection, which is formed by the DC coupling element 16 and the further DC coupling element 17, wherein a screw connection can additionally be configured to secure the plug connection. The connection could also only be in the form of a screw connection.

The electric vehicle 2 according to aspects of the invention with the charging interface device 1 according to a third exemplary embodiment is configured as illustrated in FIG. 7. The body 12 has an air-conducting element 26, which is configured to be movable, in the area of the element opening 22.

In FIG. 8, the charging module 13 is depicted in a schematic diagram in a sectional view. The charging lid 10 is configured to be swiveling, and is disposed over the charging socket 4 during charging of the traction battery. This position of the charging lid 10 is shown as dashed in FIG. 8.

### LIST OF REFERENCE NUMERALS

1 Charging interface device
2 Electric vehicle
3 Charging cradle
4 Charging socket
5 Charging socket holder
6 AC line
7 DC line
8 Plug connection means
9 Opening
10 Charging lid
11 Cradle opening
12 Body
13 Charging module
14 End
15 AC coupling element
16 DC coupling element
17 Additional DC coupling element
18 Outer surface
19 Side wall
20 Retaining element
21 Rear cladding
22 Element opening
23 Operator interface
24 Groove
25 Shell part
26 Air-conducting element
27 Receiving device
28 Coupling unit
29 Connection element
30 Rear wall
31 Additional AC coupling element
A Distance

What is claimed is:

1. An electric vehicle comprising:
a charging interface device configured to charge a traction battery of the electric vehicle, wherein the charging interface device comprises:
(i) a charging cradle,
(ii) a charging socket disposed in the charging cradle, and
(iii) power lines disposed between the charging socket and the traction battery, said power lines including an AC power line and a DC power line,
wherein the charging socket is configured to be integrated into the charging cradle, and
wherein at least the DC power line is mechanically connected to the charging cradle.

2. The electric vehicle according to claim 1, wherein the charging cradle comprises a DC coupling element for establishing a connection between the DC current line and the charging cradle, wherein the DC coupling element is at least partially complementary to a DC current coupling element of the DC power line.

3. The electric vehicle according to claim 1, further comprising a separable connection formed between the charging cradle and the charging socket.

4. The electric vehicle according to claim 1, wherein the charging socket is movable relative to the charging cradle.

5. The electric vehicle according to claim 1, wherein the charging socket is integrated into the charging cradle with the aid of a receiving device.

6. The electric vehicle according to claim 1, wherein the AC power line is a flexible line and the DC power line is a rigid line.

7. The electric vehicle according to claim 1, wherein the connection between the charging cradle and the DC power line is configured to provide for temperature compensation and/or tolerance compensation.

8. The electric vehicle according to claim 1, wherein the DC power line is connected to the charging cradle by a screw connection.

9. The electric vehicle according to claim 1, wherein the charging cradle is mounted to a retaining element of a trim part of a body of the electric vehicle.

10. The electric vehicle according to claim 9, wherein the retaining element comprises a movable air-conducting element.

11. The electric vehicle according to claim 9, wherein the trim part is a rear cladding of the electric vehicle.
